(19) United States
(12) Patent Application Publication
(10) Pub. No.: US 2009/0280315 A1
(43) Pub. Date: Nov. 12, 2009

(54) RESIN COMPOSITION, ELECTRONIC APPARATUS, AND METHOD OF MANUFACTURING ELECTRONIC APPARATUS

(75) Inventors: Minoru Tazoe, Tokyo (JP); Akihiro Yano, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/463,608

(22) Filed: May 11, 2009

(30) Foreign Application Priority Data
May 12, 2008 (JP) 2008-125188

(51) Int. Cl. B32B 5/16; B05D 5/10; C08K 3/40; C08K 3/34

(52) U.S. Cl. 428/323; 427/516; 524/494; 524/445

(57) ABSTRACT

A resin composition including an ultraviolet curing resin and ultraviolet-transmitting spherical filler particles having a diameter of 100 μm to 600 μm is provided.

### BACKGROUND OF THE INVENTION

1. Field of the Invention

The present invention relates to a resin composition that contains an ultraviolet curing resin and filler. The present invention also relates to an electronic apparatus in which an electronic component or an optical component is bonded using such a resin composition.

2. Description of the Related Art

In an apparatus such as an optical head used for optical disc, an optical component has been desired to be fixed at a position with high accuracy (e.g., see Japanese Unexamined Patent Application Publication No. 11-306567, Japanese Unexamined Patent Application Publication No. 2000-163774, and Japanese Unexamined Patent Application Publication No. 2003-59066).

The smaller the size of the electronic or optical component is, the more the difficulty of using a securing component such as a screw increases.

In addition, since it is desired to carry out the fixation after adjusting the position, inclination, or the like of an optical component, an adhesive is used for fixing the optical component to another component, such as a base or a chip.

### SUMMARY OF THE INVENTION

When an electronic component or an optical component is fixed, an ultraviolet curing resin may be used as an adhesive.

As compared with the use of a heat curing resin, the use of the ultraviolet curing resin enables curing at high speed without need of heat treatment, reducing the thermal loading on the electronic or optical component.

However, when curing the ultraviolet curing resin after adjusting the position of the component, the component may be shifted tens of micrometers from its desired position as a result of curing shrinkage.

This kind of misalignment will be described with reference to FIGS. 1A, 1B (plan views) and FIGS. 2A, 2B (cross-sectional views).

FIGS. 1A and 2A illustrate an example in the case of bonding an optical component 51 to a base or the like as another component 52 using an adhesive 53 made of an ultraviolet curing resin.

After applying the adhesive 53 to the contact area between the optical component 51 and the component 52, the position of the optical component 51 is adjusted in all directions with respect to its front and back sides, right and left sides, height, and inclination. Then, the center of optical component 51 corresponds to the intersection of broken chain lines 61A and 61B as shown in FIG. 1A.

Subsequently, an ultraviolet (UV) ray irradiator 54 is used to irradiate the adhesive 53 with UV rays 55. As a result, the ultraviolet curing resin of the adhesive 53 cures to become a cured material 53A. At this time, however, the ultraviolet curing resin shrinks as indicated by the arrows 56 in FIG. 2B, thereby displacing the optical component 51, for example, in the direction shown by the arrow 57. As a result, the center of the optical component 51 may be shifted from the intersection of the broken chain lines 61A and 61B to the intersection of broken chain lines 62A and 62B in the lower left direction as shown in FIG. 1B.

There are two kinds of ultraviolet curing resin, acrylic resin and epoxy resin.

The price of the epoxy resin is three or more times higher than that of the acrylic resin.

In contrast, the curing shrinkage of acrylic resin is almost eight times higher than that of epoxy resin.

Therefore, when ultraviolet curing resin is used to fix an electronic component or an optical component, it is difficult to satisfy both the cost reduction and high positional accuracy.

It is desirable to provide a resin composition with low curing shrinkage, which contains an ultraviolet curing resin. It is further desirable to provide an electronic apparatus in which an electric component or an optical component is bonded using such a resin composition and a method of manufacturing such an electronic apparatus.

According to an embodiment of the present invention, there is provided a resin composition including an ultraviolet curing resin and ultraviolet-transmitting spherical filler particles having a diameter of 100 μm to 600 μm.

According to another embodiment of the present invention, there is provided an electronic apparatus that includes an electronic component or an optical component and an adhesive for fixing the electronic or optical component to another component. Here, the adhesive includes ultraviolet-transmitting spherical filler particles having a diameter of 100 μm to 600 μm in a cured material of an ultraviolet curing resin.

According to further embodiment of the present invention, there is provided a method of manufacturing an electronic apparatus that includes an electronic component or an optical component.

Here, the method includes the step of applying an adhesive to bond the electronic or optical component to another component. The adhesive contains an ultraviolet curing resin and ultraviolet-transmitting spherical filler particles having a diameter of 100 μm to 600 μm.

The method also includes the step of irradiating the adhesive with ultraviolet rays to cure the adhesive.

The resin composition of the above embodiment of the present invention contains both the ultraviolet curing resin and the filler, particles of which are spherical. Thus, the degree of shrinkage at the time of curing the ultraviolet curing resin can be reduced by filling the resin with the filler particles.

In addition, since a diameter of the filler particles is in a range of 100 μm to 600 μm and the particles are spherical in shape, the filling amount thereof can be increased and the filler particles can be retained in place by their contacts with each other.

Furthermore, the filler particles transmit ultraviolet rays. Thus, the ultraviolet rays can be introduced into the entire resin and efficiently cure the resin in a short time as compared with the case in which filler particles that may not transmit ultraviolet rays are used.

In the electronic apparatus according to the embodiment of the invention, as mentioned above, the adhesive for fixing the electronic component or the optical component to another component contains ultraviolet-transmitting spherical filler particles having a diameter of 100 μm to 600 μm in a cured material of an ultraviolet curing resin. Therefore, a curing shrinkage of the adhesive during manufacture can be reduced, improving the accuracy of position of the component.

According to the above embodiment of the present invention, the method of manufacturing an electronic apparatus uses a resin composition including an ultraviolet curing resin and ultraviolet-transmitting spherical filler particles having a diameter of 100 μm to 600 μm. The method includes the steps of applying the adhesive so that the electronic component or the optical component is bonded to another component and irradiating the adhesive with ultraviolet rays to cure the adhesive.

Therefore, a curing shrinkage of the adhesive can be reduced, suppressing the component from being shifted due to the shrinkage.

According to the above embodiment of the present invention, since the resin composition can reduce the degree of shrinkage at the time of hardening, the use thereof can suppress the shift due to the shrinkage of a component to which the resin composition is applied as an adhesive.

In addition, an inexpensive ultraviolet curing resin with a high degree of shrinkage can be used, so that the cost of an adhesive can be reduced.

According to the above embodiment of the present invention, components in the electronic apparatus have a high positional accuracy. Thus, the electronic apparatus with desired properties can be manufactured stably with a high yield.

According to the above embodiment of the present invention, the method of manufacturing an electronic apparatus causes less curing shrinkage of an adhesive. Thus, the shift due to the shrinkage of a component can be suppressed and the electronic apparatus with desired properties can be manufactured stably with a high yield.

Therefore, according to the above embodiments of the present invention, an electronic component or an optical component can be fixed to another component (such as a base, a component, or a chip) with accuracy. It becomes possible to manufacture an electronic apparatus having an electronic component or an optical component stably with a high yield.

### BRIEF DESCRIPTION OF THE DRAWINGS

FIGS. 1A and 1B are plan views of an optical component on a base, where FIG. 1A illustrates the state of applying an ultraviolet curing resin as an adhesive to fix them in place and FIG. 1B illustrates the state of curing after the application.

FIGS. 2A and 2B are sectional views of an optical component on a base, where FIG. 2A illustrates the state of applying an ultraviolet curing resin as an adhesive to fix them in place and FIG. 2B illustrates the state of curing after the application.

FIGS. 3A and 3B are schematic perspective views illustrating the suppression of curing shrinkage when using filler, where FIG. 3A is in the absence of filler and FIG. 3B is in the presence of filler.

FIGS. 4A and 4B are schematic cross-sectional views illustrating the support by filler particles, where FIG. 4A illustrates the state before UV irradiation and FIG. 4B illustrates the state after UV irradiation.

FIG. 5 is a schematic cross-sectional view illustrating a resin composition according to an embodiment of the present invention.

FIG. 6 is a schematic cross-sectional view illustrating a coater for applying a resin composition.

FIGS. 7A and 7B are plan views illustrating the application of an adhesive to components at two positions in FIG. 7A and four positions in FIG. 7B.

FIGS. 8A and 8B are cross-sectional views illustrating the state of curing when the resin composition of FIG. 5 is used as an adhesive, where FIG. 8A and FIG. 8B illustrate different steps.

FIG. 9 is a graphic diagram illustrating the relationship between the filling amount of filler particles and the displacement of a component.

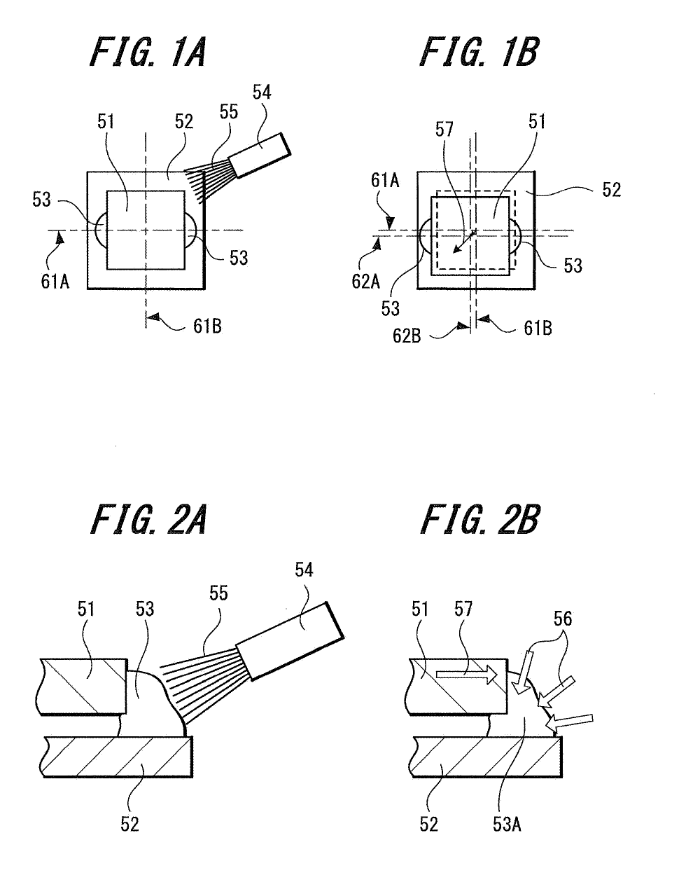

### DESCRIPTION OF THE PREFERRED EMBODIMENTS

Embodiments of the present invention will be briefly described in advance of specific descriptions thereof.

According to an embodiment of the present invention, a resin composition includes an ultraviolet curing resin and ultraviolet-transmitting spherical filler particles having a diameter of 100 μm to 600 μm.

It is desirable that the ultraviolet curing resin and the filler particles are mixed uniformly or almost uniformly.

According to another embodiment of the present invention, an electronic apparatus includes an electronic component or an optical component and an adhesive for fixing the electronic or optical component to another component. The adhesive contains the ultraviolet-transmitting filler particles in a cured material of an ultraviolet curing resin.

In addition, according to further embodiment of the present invention, for manufacturing an electronic apparatus having an electronic component or an optical component, steps of applying the adhesive to bond the electronic or optical component and another component and irradiating the adhesive with ultraviolet rays are carried out.

The ultraviolet curing resin used may be an epoxy resin or an acrylic resin.

The material of the filler particles used may be any of ultraviolet-transmitting materials. For example, it may be one or more materials selected from glass, ceramics, and plastics.

Since the filler particles allow ultraviolet rays to pass therethrough, the ultraviolet rays can also be applied to the ultraviolet curing resin through the filler particles.

Therefore, ultraviolet rays can be incident on the resin composition to the inside thereof to efficiently cure the resin in a short period.

The amount of ultraviolet curing resin to be used can be reduced by filling the ultraviolet curing resin with spherical filler particles. Thus, it can reduce and suppress the degree of shrinkage of the resin at the time of curing.

In addition, when shrinking, the spherical filler particles are brought into contact with each other and the filler particles being contacted with each other are then supported by each other. It can also suppress the shrinkage of resin at the time of curing.

Preparing the filler particles in spherical shape with a diameter of 100 μm to 600 μm allows the ultraviolet curing resin to be filled with the more amount thereof.

If the diameter of particles is larger than that, a gap between the adjacent filler particles will become large, resulting in a difficulty of filling the ultraviolet curing resin with the more amount thereof.

If the diameter of particles is smaller than that, viscosity tends to be increased when mixing with the resin. It becomes difficult to uniformly mix the filler particles with the resin when filling the resin with the more amount thereof. Besides, it becomes difficult to cure the resin in a short time, because such advantageous effects of allowing the ultraviolet rays to be incident on the resin composition to the inside thereof may be reduced.

If the filler particles have projections and depressions on the surfaces thereof, a filling ratio per unit volume will be decreased. If the filler particles are of a cylindrical shape, it will be difficult to mix the filler particles uniformly with the resin.

A preferable range of a filling amount of spherical filler particles depends on the type of the resin and the material and diameter of the filler particles.

For example, in the case where the ultraviolet curing resin is an epoxy resin or an acrylic resin and the spherical filler particles are made of glass beads, the amount of the spherical filler particles in the entire resin composition is preferably in a range of 10 mass % to 60 mass %.

If the filling amount of the spherical filler particles is lower than that, such advantageous effects of suppressing the curing shrinkage of resin and curing the resin quickly may be reduced.

If the filling amount of the spherical filler particles is higher than that, it becomes difficult to uniformly mix the filer particles in the ultraviolet curing resin.

In addition, for lowering the degree of shrinkage as possible when cured, it is desirable to increase the filling amount of the spherical filler particles close to the limit at which the filler particles and resin can be mixed almost uniformly.

The resin composition may include a solvent, an additive, or any other filler in addition to the ultraviolet curing resin and the filler of spherical particles.

Here, the other filler may be any of those with smaller particle diameters ranging from several micrometers to tens of micrometers which have been used and mixed with an ultraviolet curing resin. However, for increasing the amount of the spherical filler particles to be mixed and carrying out uniform mixing, it is desirable to reduce the amount of the other filer with small particle diameters more than ever.

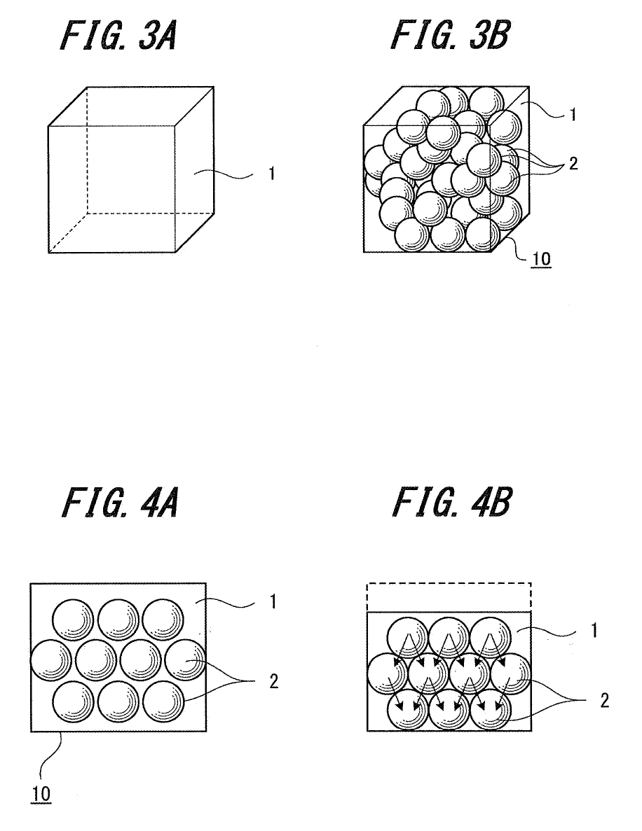

Referring now to FIGS. 3A and 3B, the curing shrinkage suppression by the filler particles will be described.

As shown in FIG. 3A, if there is only an ultraviolet curing resin 1, the resin shrinks when cured.

In contrast, as shown in FIG. 3B, when spherical filler particles 2 are mixed in the ultraviolet curing resin 1 to prepare a resin composition 10, the amount of ultraviolet curing resin 1 used in the entire resin composition 10 can be reduced compared with one shown in FIG. 3A. For example, the amount of ultraviolet curing resin 1 used is reduced to 60% by being filled with 40% of the spherical filler particles 2.

Thus, since the amount of ultraviolet curing resin 1 used is reduced, the degree of shrinkage of the resin composition 10 when cured can be reduced. Thus, it becomes possible to suppress the shrinkage of the resin composition 10.

Referring now to FIGS. 4A and 4B, a mechanism of support between filler particles in the resin will be described.

In the state before curing, as shown in FIG. 4A, the spherical filler particles 2 are mixed in the ultraviolet curing resin 1.

In some cases, the spherical filler particles 2 may not be separated from each other. In many cases, however, the spherical filler particles 2 are separated from each other in the ultraviolet curing resin 1.

If the ultraviolet curing resin 1 is irradiated with ultraviolet rays and cured, as shown in FIG. 4B, the entire ultraviolet curing resin 1 tends to shrink. At this time, the spherical filler particles 2 are brought into contact with each other and the force as indicated by the arrows is then applied to the filler particles 2 contacting with each other. As a result, the filler particles 2 can be supported in contact with each other.

In the electronic apparatus and the method of manufacturing such an electronic apparatus according to an embodiment of the present invention, an electronic component or an optical component to be bonded may be any of those that require some degree of accuracy of position. Thus, the electronic apparatus and the method of manufacturing such an electronic apparatus according to an embodiment of the present invention can be widely applied.

The electronic components include semiconductor chips, such as ICs and LSIs and various other components such as resistors and capacitors.

The optical components include opto-electronic integrated circuits (OEICs) which serve as electronic components. The optical components further include optical heads, light-emitting elements (e.g., semiconductor lasers and light-emitting diodes), light-receiving elements, lenses, prisms, light guides, wavelength plates, beam splitters, and optical waveguides.

Next, the embodiments of the present invention will be described in more details.

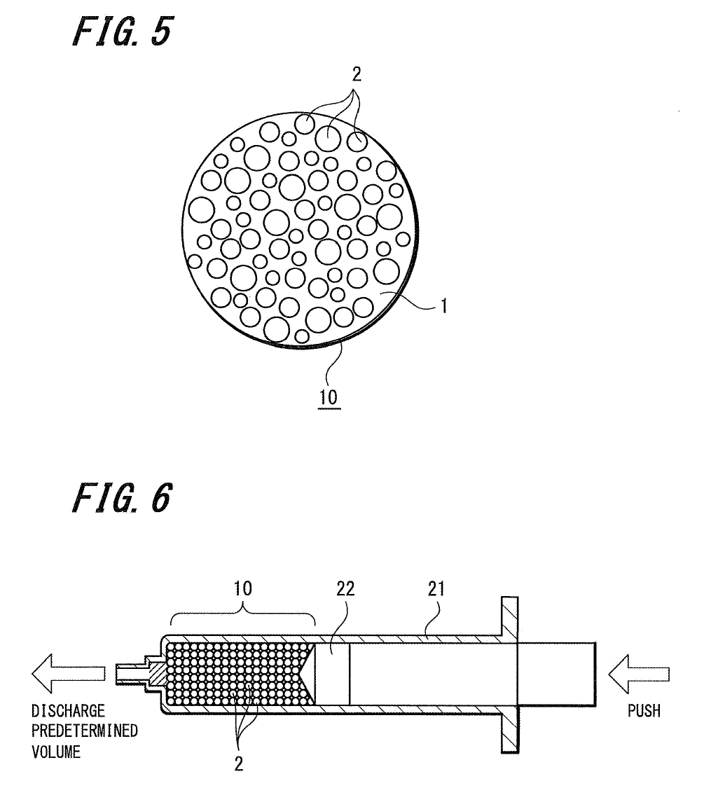

FIG. 5 is a cross sectional view illustrating a resin composition according to an embodiment of the present invention. A resin composition 10 is prepared by mixing ultraviolet-transmitting spherical filler particles 2 in an ultraviolet curing resin 1.

The ultraviolet curing resin 1 may be made of, for example, an epoxy resin or an acrylic resin.

The spherical filler particles 2 may be made of any of ultraviolet-transmitting materials including glass, ceramics, and plastics.

The diameter of the spherical filler particles 2 is in a range of 100 μm to 600 μm.

The resin composition 10 may further include a solvent, an additive, any kind of other filler, and so on, if required, in addition to the ultraviolet curing resin 1 and the spherical filler particles 2.

The resin composition 10 shown in FIG. 5 can be produced in a manner similar to the related-art resin composition containing filler in an ultraviolet curing resin.

For example, the resin composition 10 can be produced by dissolving the ultraviolet curing resin 1 in a solvent, adding spherical filler particles 2 in the solvent, and mixing the filler particles 2 therein while being stirred.

The resin composition 10 of the present embodiment can be used in an electronic apparatus having an electronic component or an optical component. In particular, the resin composition 10 can be used for bonding an electronic component or an optical component to another component (e.g., a base, a structural member, or a chip).

When actually using the resin composition 10, the resin composition 10 is applied to bond the electronic component or the optical component and another component, and the ultraviolet curing resin 1 is then cured by irradiation of ultraviolet rays.

This will be in the state of containing spherical filler particles 2 in a cured material of ultraviolet curing resin 1.

A coater as shown in FIG. 6 may be used for applying the resin composition 10.

As shown in FIG. 6, the coater includes a syringe 21 with a plunger 22 for pushing the content out of the syringe 21.

The resin composition 10 prepared by mixing the spherical filler particles 2 with the ultraviolet curing resin 1 is placed in the coater. Then, the plunger 22 is pressed to discharge a predetermined volume of the resin composition 10.

The pressure applied to the plunger 22 is preferably in a range of 0.1 MPa to 0.5 MPa.

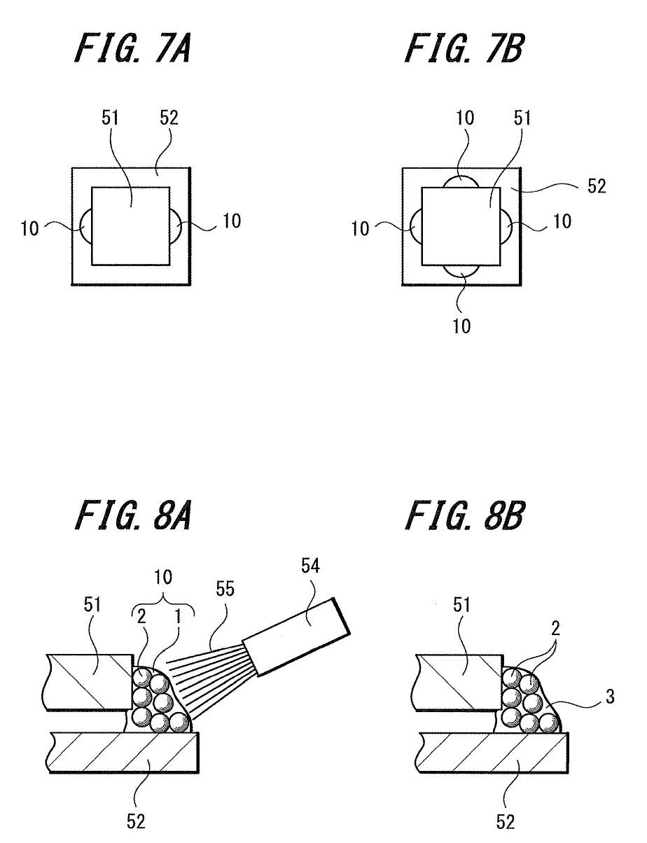

Furthermore, for example, the resin composition 10 may be applied as illustrated in a plan view of FIG. 7A. That is, in the case of applying the resin composition 10, the resin composition 10 may be used as an adhesive applied to both the left and light sides of an optical component or electronic component 51, where another component (e.g., a base, a member, or a chip) 52 is bonded.

In addition, as illustrated in a plan view of FIG. 7B, the resin composition 10 may be used as an adhesive applied to four portions on the front, back, right, and left sides of the optical or electronic component 51, where another component 52 is bonded.

Here, the state of curing in the case of using the resin composition 10 of the present embodiment as an adhesive will be described with reference to FIGS. 8A and 8B, which are cross-sectional views similar to those shown in FIGS. 2A and 2B.

As shown in FIG. 8A, the resin composition 10, which is prepared by mixing the ultraviolet curing resin 1 with spherical filler particles 2, is provided as an adhesive and applied to bond the optical or electronic component 51 and another component 52.

Subsequently, the orientation of the optical or electronic component 51 (i.e., the positions of four sides, the height, and the inclination thereof) is adjusted to be appropriate.

Subsequently, the resin composition 10 is irradiated with ultraviolet rays 55 from an ultraviolet (UV) irradiator 54.

As a result, as shown in FIG. 8B, the ultraviolet curing resin 1 in the resin composition 10 is cured resulting in a cured material 3 containing the spherical filler particles 2. In this case, since the resin composition 10 of the adhesive includes the spherical filler particles 2, the degree of shrinkage is small. Thus, the shift of position of the optical or electronic component 51 due to the shrinkage can be suppressed.

According to the above embodiment, the resin composition 10 is prepared by mixing the ultraviolet curing resin 1 with the ultraviolet-transmitting spherical filler particles 2. Thus, the amount of ultraviolet curing resin 1 used is reduced and the degree of shrinkage thereof when cured can be reduced.

In addition, since the filler particles 2 are brought into contact with each other and supported by each other, the degree of shrinkage at the time of curing can be reduced.

Since the filler particles 2 transmit ultraviolet rays, the ultraviolet rays can also be applied to the ultraviolet curing resin 1 through the filler particles 2. Therefore, ultraviolet rays can be incident on the resin composition 10 to the inside thereof to efficiently cure the ultraviolet curing resin 1 in a short period.

Furthermore, the filler particles 2 are formed in spherical shape with a particle diameter of 100 μm to 600 μm, allowing the ultraviolet curing resin 1 to be filled with more filler particles 2.

According to the above embodiment of the present invention, furthermore, the degree of shrinkage can be kept low even if an inexpensive acrylic resin with a large degree of shrinkage is used. It means that costs of an adhesive using an ultraviolet curing resin can be lowered.

When bonding an electronic component or an optical component to another component in an electronic apparatus using the resin composition 10 of the present embodiment as an adhesive, a low degree of shrinkage is attained at the time of curing. Thus, the shift of position of the electronic or optical component can be suppressed, attaining an improved position accuracy of the component.

### Experiment

Here, the displacement of bonded component was determined with the varied amounts of spherical filler particles in the resin.

The ultraviolet curing resin used was 8150 (thermal denaturation acrylate, manufactured by Kyoritsu Chemical & Co., Ltd.) and the spherical filler particles used were UB-911L (glass beads, manufactured by Union Co., Ltd.

Spherical filler particles of different filling amounts of 0 (no filler), 10, 30, 50, and 60 mass % were mixed with the ultraviolet curing resin to prepare resin compositions, respectively.

Here, a resin composition containing 70 mass % of filler particles could not be prepared because such a filling amount of the filler particles could not be mixed with the resin uniformly.

Each of the resin compositions with different filling amounts of filler particles was used for bonding a component on a base. Ten samples with bonded components were prepared for each of the resin compositions with different filling amounts of filler particles.

The positions of components of the respective samples were determined and then irradiated with ultraviolet rays to cure the resin compositions, respectively.

The position of the component after the curing was determined and the displacement of the component from the position before the curing to the position after the curing was then determined.

Furthermore, an average amount of displacement of 10 samples with an equal filling amount of filler particles was determined.

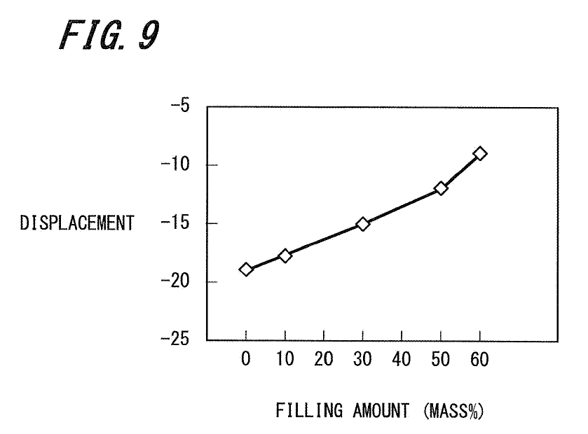

As results thus obtained the relationship between the average amount of displacement of the component and the filling amount of spherical filler particles is represented in FIG. 9.

As shown in FIG. 9, the more the filling amount of spherical filler particles increases, the less the average amount of displacement becomes.

Furthermore, for obtaining a certain degree of shrinkage suppressing effects with the combination of the resin and filler particles in this experiment, a required filling amount of spherical filler particles may be 10 mass % or more.

As mentioned above, it is difficult to mix uniformly when the filling amount of spherical filler particles is 70 mass %.

Therefore, it is found that a desirable filling amount of the spherical filler particles is in a range of 10 mass % to 60 mass % with an allowance of the upper limit thereof.

The present invention is not limited to any of the above embodiments but can be embodied in any of various configurations without departing from the gist of the present invention.

The present application contains subject matter related to that disclosed in Japanese Priority Patent Application JP 2008-125188 filed in the Japan Patent Office on May 12, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A resin composition comprising:
an ultraviolet curing resin; and
ultraviolet-transmitting spherical filler particles having a diameter of 100 μm to 600 μm.

2. The resin composition according to claim 1, wherein
the filler particles are made of at least one material selected from the group consisting of glass, ceramics, and plastics.

3. The resin composition according to claim 1,
wherein the ultraviolet curing resin is one of an epoxy resin and an acrylic resin, and
wherein the filler particles are made of glass beads and an amount thereof is in a range of 10 to 60 percent by mass of the resin composition.

4. An electronic apparatus, comprising:
a first electronic or optical component; and
an adhesive for fixing the first electronic or optical component to a second component, wherein
the adhesive contains ultraviolet-transmitting spherical filler particles having a diameter of 100 μm to 600 μm in a cured material of an ultraviolet curing resin.

5. A method of manufacturing an electronic apparatus having a first electronic or optical component, comprising the steps of:
applying an adhesive to bond the first electronic or optical component to a second component, where the adhesive contains an ultraviolet curing resin and ultraviolet-transmitting spherical filler particles having a diameter of 100 μm to 600 μm; and
irradiating the adhesive with ultraviolet rays to cure the adhesive.
